(19) United States
(12) Patent Application Publication
(10) Pub. No.: US 2007/0071583 A1
(43) Pub. Date: Mar. 29, 2007

(54) SUBSTRATE INDEXING SYSTEM

(75) Inventor: You Yang Ong, Singapore (SG)

Correspondence Address: ISHIMARU & ZAHRT LLP, 333 W. EL CAMINO REAL, SUITE 330, SUNNYVALE, CA, 94087, US

(73) Assignee: STATS CHIPPAC LTD., Singapore (SG)

(21) Appl. No.: 11/162,971

(22) Filed: Sep. 29, 2005

(51) Int. Cl. B65G 65/04; B65B 69/00; B65B 21/02; B65F 3/02; B65G 65/34

(52) U.S. Cl. 414/403; 414/416.01

(57) ABSTRACT

A substrate indexing system comprising aligning a substrate with an indexing system, drawing the substrate along a long axis of the indexing system, and engaging the substrate using a self-aligning resilient tensioner with a chamfered edge.

### TECHNICAL FIELD

The present invention relates generally to integrated circuit manufacturing, and more particularly to a system for substrate indexing during integrated circuit manufacturing.

### BACKGROUND ART

During a soft solder die attach process, a leadframe strip is transferred and indexed along a heater tunnel. A soft solder is dispensed at the center region of the leadframe and a die bonder tool places the back of an integrated circuit (“IC”) chip onto the soft solder at the front end of the heater tunnel. After the chip is placed on the leadframe, the leadframe is indexed along the heater tunnel to eutectically alloy the IC chip to the leadframe.

Soft solder die attach processes use high working temperatures for solder wire dispensing, spanking and mounting of power semiconductor chips. A heated tunnel, supplied with forming gas, often 95% nitrogen and 5% hydrogen, is used to transport the bonding substrate or leadframe with a specific temperature profile. Within a 1.5 meter to 2 meter length of heated tunnel, approximately 22-30 heater coils are installed at various positions to yield the required temperature profile.

The bonding substrates or leadframes that are indexed through the heating tunnels experience a drastic change of temperature from the entrance point to the exit point. Thermally induced stresses arise when different materials expand or contract at different rates when exposed to a change in temperature. The coefficient of thermal expansion (CTE) is a constant that is measured for different materials responses to changes in temperature. The CTE mismatch between different materials used to manufacture bonding substrates or leadframes can lead to warpage. In particular, large thin matrix lead frames (10-20 mil thickness) with half-etch profiles exhibit warpage tendencies.

Additionally, leadframes and bonding substrates with thicker metal portions expand beyond the expansion rate of the thinner metal portions (i.e.—the half-etch areas). This differential in expansion rate results in an outward bend of the bonding substrate or leadframe. The larger the width of the lead frame, the higher the aggregated warpage.

Bonding substrate or leadframe warpage becomes an issue when indexing cycle time is considered. Any increase in indexing cycle time, even due to minor stoppages, can reduce the output yield and make the process less cost efficient. Other related defects due to warpage may include solder dispensing volume inconsistency and die placement shift. Severe warpage can result in total process failure and a waste of leadframe material. As such, a method to minimize or prevent large matrix leadframe warpage under high working temperatures of 340-400° C. is acutely needed.

Several attempts to prevent bonding substrate or leadframe warpage during high temperature die mounting processes have been employed by others. One approach is to use an aperture extended from the top heat tunnel window at specific locations to hold down the bonding substrate. Such method is only suitable for substrates with minimal device density because more window openings would result in faster bonding substrate or lead frame in-situ oxidation. Oxidation of the bonding substrate may cause poor solder wettability and unwanted precipitation. Pre-mature device failure is a direct response of such oxidation.

In another approach, two sided indexing pins are used to balance out large matrix bonding substrates or leadframe warping. In order to operate such a system a cam shaft is attached with smaller indexing pin shafts, a dual XZ axis linear motor and actuators are required at the front and rear side of the heat tunnel. This configuration results in a larger working stage that appears to be more complex and cumbersome for maintaining and servicing.

In yet another approach, several prefixed metal bumps were used to hold down the bonding substrate or leadframe. These metal bumps are either separate or are incorporated with the heat tunnel top cover. The separate bumps are mechanically attached to the bottom side of the heat tunnel top cover while the incorporated bumps are protruding profiles that are machined directly from the heat tunnel top cover. This arrangement has limited usage flexibility where bonding substrate layout and thickness may vary from substrate to substrate. When substrate layout and thickness do vary, retooling of the heat tunnel causes unwanted down time that reduces product yield and increases cost. Finally, minor stoppages might also occur if the leadframe becomes severely warped during indexing or drawing.

Thus, despite recent developments in high temperature die mounting processes, a need still remains for an improved substrate indexing system that increases product yield by reducing stoppages due to die mounting defects.

Solutions to these problems have been long sought but prior developments have not taught or suggested any solutions and, thus, solutions to these problems have long eluded those skilled in the art.

### DISCLOSURE OF THE INVENTION

The present invention provides a substrate indexing system comprising aligning a substrate with an indexing system, drawing the substrate along an axis of the indexing system, and engaging the substrate using a self-aligning resilient tensioner with a chamfered edge.

Certain embodiments of the invention have other advantages in addition to or in place of those mentioned above. The advantages will become apparent to those skilled in the art from a reading of the following detailed description when taken with reference to the accompanying drawings.

### BRIEF DESCRIPTION OF THE DRAWINGS

FIG. 1 is a cross sectional view of a heat tunnel in accordance with an embodiment of the present invention;

FIG. 2 is a top view of a portion of the heat tunnel of FIG. 1;

FIG. 3 is a side view of a portion of the heat tunnel of FIG. 1;

FIG. 4 is a top view of a sub-assembly of a tensioner structure of FIG. 1;

FIG. 5 is a bottom view of the sub-assembly of the tensioner structure of FIG. 1;

FIG. 6 is a front view of the sub-assembly of the tensioner structure of FIG. 1;

FIG. 7 is a top view of the sub-assembly of the tensioner structure of FIG. 1;

FIG. 8 is a side view of the sub-assembly of the tensioner structure of FIG. 1;

FIG. 9 is a top view of a sub-assembly of the tensioner structure of FIG. 1 in accordance with an embodiment of the present invention;

FIG. 10 is a bottom view of the tensioner structure during insertion of the sub-assembly into the tensioner structure in a heat tunnel top cover accordance with an embodiment of the present invention;

FIG. 11 is a bottom view of the tensioner structure of FIG. 10 after locking of the sub-assembly into the tensioner structure in a heat tunnel top cover;

FIG. 12 is a cross-sectional view of the tensioner structure of FIG. 111 after locking of the sub-assembly into the tensioner structure in a heat tunnel top cover;

FIG. 13 is a top view of a dual panel bonding substrate structure in accordance with an embodiment of the present invention;

FIG. 14 is a top view of a multiple panel bonding substrate structure in accordance with an embodiment of the present invention; and

FIG. 15 is a flow chart for a substrate indexing system in accordance with an embodiment of the present invention.

### BEST MODE FOR CARRYING OUT THE INVENTION

The following embodiments are described in sufficient detail to enable those skilled in the art to make and use the invention, and it is to be understood that other embodiments would be evident based on the present disclosure and that process or mechanical changes may be made without departing from the scope of the present invention.

In the following description, numerous specific details are given to provide a thorough understanding of the invention. However, it will be apparent that the invention may be practiced without these specific details. In order to avoid obscuring the present invention, some well-known system configurations, and process steps are not disclosed in detail. Likewise, the drawings showing embodiments of the invention are semi-diagrammatic and not to scale and, particularly, some of the dimensions are for the clarity of presentation and are shown exaggerated in the drawing FIGs. In addition, where multiple embodiments are disclosed and described having some features in common, for clarity and ease of illustration, description, and comprehension thereof, similar and like features one to another will ordinarily be described with like reference numerals.

The term “horizontal” as used herein is defined as a plane parallel to the plane or surface of the bonding substrate or leadframe, regardless of its orientation. The term “vertical” refers to a direction perpendicular to the horizontal as just defined. Terms, such as “on”, “above”, “below”, “bottom”, “top”, “side” (as in “sidewall”), “higher”, “lower”, “upper”, “over”, and “under”, are defined with respect to the horizontal plane.

An embodiment of the present invention can employ one or more tensioners to hold down a leadframe or a bonding substrate during high temperature die mounting processes. The tensioners include four sections. The first section is one piece, including a bottom down holder clamp, a shaft with a clamp neck and a hemispherical bowl with protruding portions for engaging a turning lock holder insertion recess. The bottom down holder clamp is specifically chamfered to assist in smooth drawing of the leadframes or the bonding substrates during indexing. The second section includes a load transference member, such as, a ball bearing. The third section includes a self-adjusting resilient member, such as, a spiral loaded spring. The fourth section includes a compliant support, such as, a spring absorber gripper mat.

The tensioners can be installed underneath a heat tunnel top cover of soft solder machines. The tensioners prevent physical deformation of the leadframe or the bonding substrate during high temperature die mounting processes. Additionally, the tensioners enable smooth indexing of a large matrix leadframe or bonding substrate with a high density unit layout. Therefore, since the present invention enables smooth indexing of the leadframe or the bonding substrate and prevents physical deformation of the leadframe or the bonding substrate, a stable bonding surface can be produced for a high temperature die mounting process.

An embodiment of the present invention may comprise one or more self-adjusting tensioners installed at various locations beneath the heat tunnel top cover from the entrance to the exit of a heat tunnel. The tensioners are used to control and continuously hold down the leadframe or the bonding substrate during indexing. These tensioners can be configured for installation in a myriad of zones, including but not limited to: preheat I, preheat II, preheat III, preforming, spanking, mounting and cooling zones.

Indexing occurs by superimposing, at a front rail portion of the heat tunnel, the leadframe or the bonding substrate indexing rail over the rail of the heat tunnel. The one or more openings within the heat tunnel top cover and the indexing rail of the leadframe or the bonding substrate are engaged by one or more indexing pins, which enables the leadframe or the bonding substrate to be walked through the heating tunnel.

Tensioners of the present invention can be made from a tungsten carbide material, coated with titanium. The titanium coating helps to prevent solder adhesion to the tensioner. After many cycles, tensioners not coated with titanium become coated with a solder residue, which can affect the exterior surface of the tensioners.

Each tensioner includes a bottom down holder clamp, which may have its left and right leading side edges chamfered at about a 35° taper to avoid direct collision of the leadframe or the bonding substrate during the drawing process. The leading front edge of the bottom down holder clamp is also tapered. The leading front edge can be tapered at about 11°. The leading front edge of the bottom down holder clamp is tapered to facilitate indexing of the leadframes or the bonding substrates. The trailing edge of the bottom down holder clamp is also tapered to about 35°. This tapering helps to reduce stress that is imparted when the leadframes or the bonding substrates disengage from the tensioners.

The effectiveness of the tensioners relies on its capability to hold down the walking leadframe or bonding substrate in a hot working environment. Each tensioner can hold down the walking leadframe or bonding substrate in a hot working environment because it possesses the unique ability to self-level and self-align to the walking leadframe or bonding substrate. Initially, each tensioner is self-adjusting due to a gap between the hemispherical bowl and the ball bearing. This gap allows the first section to pivot upon the protruding portions within the pivot lock holder insertion recess before it engages the spiral loaded spring. The gap between the hemispherical bowl and the ball bearing can be about 3 mils.

As the hemispherical bowl and the ball bearing come into contact, each tensioner is then further self-leveled and self-aligned due to a force or load of a spiral loaded spring, which engages the ball bearing. One end of the spring exerts its load or force upon the ball bearing and the other end of the spring exerts its load or force upon the heat tunnel top cover. By applying a load or force to the ball bearing, which acts upon the hemispherical bowl, and consequently, the bottom down holder clamp, the tensioner is able to hold down the walking leadframe or bonding substrate and prevent warpage.

An advantage of the spiral loaded spring tensioner is its ability to automatically adjust to varying leadframe thickness or bonding substrate thickness (i.e.—from a 10 mil thickness to a 20 mil thickness) without adjusting or dismantling the tensioner unit. This advantage clearly reduces the machine conversion time for different thickness leadframes or bonding substrates.

Due to the temperature difference at each location in the heat tunnel, CTE mismatch is considered a prominent issue for the leadframe or the bonding substrate quality. CTE mismatch can cause the leadframe or the bonding substrate to warp. An embodiment of the present invention employs the above-mentioned self-aligned tensioners beneath the heat tunnel top cover to hold down the leadframe or the bonding substrate, thereby preventing the leadframe or the bonding substrate from warping. This technique provides a more stable and robust bonding platform for soft solder die attach processes, which increases bonding accuracy and thereby improves product yield.

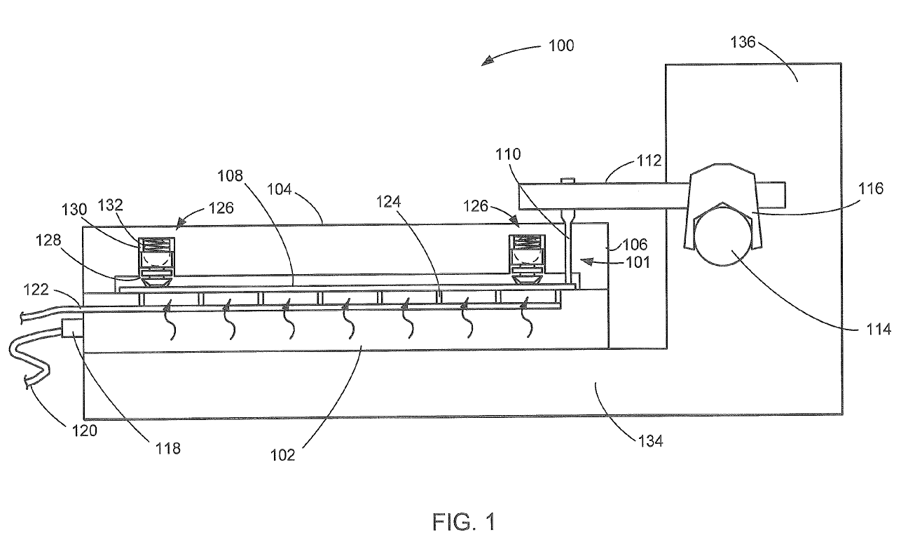

Referring now to FIG. 1, therein is shown a cross sectional view of a heat tunnel 100 in accordance with an embodiment of the present invention. The heat tunnel 100 includes a heat tunnel bed 102 and a heat tunnel top cover 104. The heat tunnel top cover 104 possesses sides 106 that extend vertically downwards from the top of the heat tunnel top cover 104 to the top of the heat tunnel bed 102. The heat tunnel bed 102 supports a leadframe or a bonding substrate 108.

The heat tunnel 100 further includes a substrate indexing system 101 that includes one or more indexing pins 110. The indexing pins 110 walk the leadframe or the bonding substrate 108 along an axis of the heat tunnel 100. The indexing pins 110 are held by one or more indexing arms 112, which is connected to a cam shaft 114 by an indexing arms adaptor 116. In one embodiment, the cam shaft 114 is powered by a linear motor (not shown) that turns in two directions. The cam shaft 114 acts upon the indexing arms adaptor 116, which causes the indexing arms 112 to reciprocate. Alternatively, the linear motor (not shown) could just turn in one direction and the cam shaft 114 could travel a helix type path, thereby imparting a reciprocating motion to the indexing arms 112. Either way, the combined motion of the linear motor (not shown), the cam shaft 114, the indexing arms adaptor 116, the indexing arms 112 and the indexing pins 110, acts to pull the leadframe or the bonding substrate 108 into and out of the heat tunnel 100.

In addition to supporting the leadframe or the bonding substrate 108, the heat tunnel bed 102 also transfers heat from heater coils 118 to the leadframe or the bonding substrate 108 for the high temperature die mounting process. The heater coils 118 distribute energy delivered by heater coil wires 120, which are connected to a heat source (not shown). Additionally, the heat tunnel bed 102 provides a forming gas supply tube 122 for delivering a forming gas to forming gas outlets 124. As mentioned above, the forming gas may be comprised by nitrogen and hydrogen.

The substrate indexing system 101 additionally includes one or more tensioner structures 126. The tensioner structures 126 engage the leadframe or the bonding substrate 108 surface as the leadframe or the bonding substrate 108 is indexed through the heat tunnel 100. The tensioner structures 126 provide a downward force that secures the leadframe or the bonding substrate 108 between the tensioner structures 126 and the heat tunnel bed 102. To facilitate smoothness of a forward moving direction of the leadframe or the bonding substrate 108, the tensioner structures 126 possesses a chamfered leading edge. The chamfered leading edge reduces the stress produced from the collision of the tensioner structures 126 and the leadframe or the bonding substrate 108 during the drawing process.

The tensioner structures 126 are configured within one or more heat tunnel top cover apertures 128 within the heat tunnel top cover 104. During assembly of the tensioner structures 126, a spring absorber gripper mat 130 is initially inserted into the one or more heat tunnel top cover apertures 128. After the spring absorber gripper mat 130 is put in, a spring absorber 132 is inserted and held in place by the spring absorber gripper mat 130. After securing the spring absorber 132, a ball bearing can be placed within the hemispherical bowl of the first section and this entire subassembly can be inserted, and rotated 90° to a locked position, within the one or more heat tunnel top cover apertures 128. Alternatively, the ball bearing can be pushed into the spring absorber 132 first, and then the first section is inserted and rotated 90° to a locked position, into the one or more heat tunnel top cover apertures 128 within the heat tunnel top cover 104.

The heat tunnel 100 also includes a workholder base 134 for supporting the heat tunnel bed 102. The workholder base 134 is connected to a vertical workholder chassis 136 which supports the indexing structure comprised by the linear motor (not shown), the cam shaft 114, the indexing arms adaptor 116, the indexing arms 112 and the indexing pins 110.

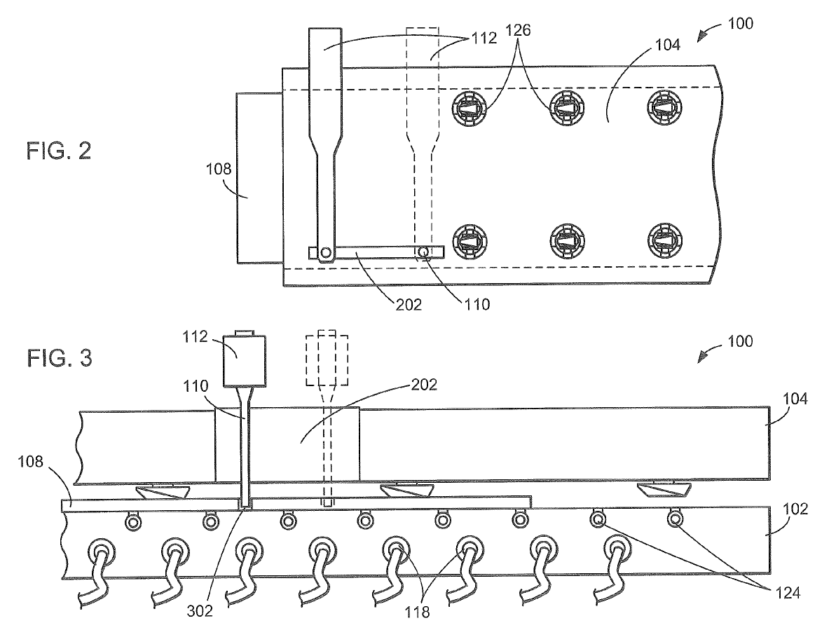

Referring now to FIG. 2, therein is shown a top view of a portion of the heat tunnel 100 of FIG. 1. FIG. 2 depicts one or more openings 202 formed within the heat tunnel top cover 104. The openings 202 allow the indexing pins 110 to engage the leadframe or the bonding substrate 108 and walk the leadframe or the bonding substrate 108 through the heat tunnel 200 while the tensioner structures 126 prevent warpage. Although FIG. 2 depicts an embodiment wherein the indexing arms 112 engage the indexing rail furthest from the cam shaft (not shown), the indexing arms 112 can be shortened so as to engage the indexing rail closest to the cam shaft. Correspondingly, the openings 202 would be moved over the indexing rail closest to the cam shaft.

Referring now to FIG. 3, therein is shown a side view of a portion of the heat tunnel 100 of FIG. 1. The side view of the heat tunnel 100 depicts the heat tunnel bed 102, the leadframe or the bonding substrate 108, the indexing pins 110, the indexing arms 112, the heater coils 118, the forming gas outlets 124, the tensioner structures 126, the openings 202 in the heat tunnel top cover 104 and indexing holes 302. The indexing holes 302 are recesses formed within the indexing rail of the leadframe or the bonding substrate 108. The indexing pins 110 are inserted into the indexing holes 302, thereby engaging the leadframe or the bonding substrate 108 and walking it through the heat tunnel 100.

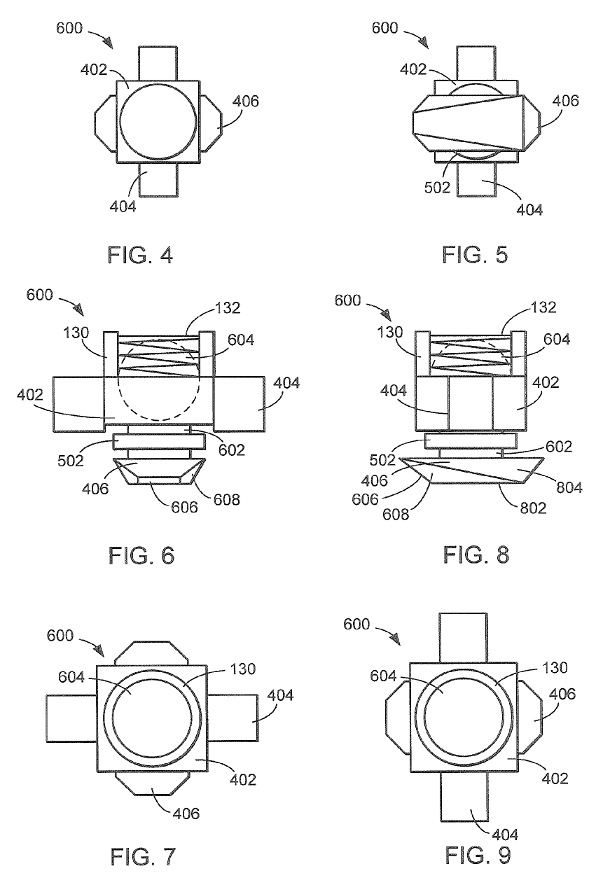

Referring now to FIG. 4, therein is shown a top view of a sub-assembly 600 of the tensioner structure 126 of FIG. 1. The tensioner structures 126 include a hemispheric bowl 402, a 90° turning lock holder 404 (i.e.—protruding portion), and a bottom down holder clamp 406. The hemispheric bowl 402 provides a female receptacle for a load transference member, such as, a ball bearing (not shown). The 90° turning lock holder 404 is a protruding portion of the tensioner structures 126 that engages a lock holder rim (not shown) machined into the heat tunnel top cover 104, of FIG. 1. The bottom down holder clamp 406 engages the leadframe or the bonding substrate 108, of FIG. 1.

Referring now to FIG. 5, therein is shown a bottom view of the sub-assembly 600 of the tensioner structure 126 of FIG. 1. The tensioner structures 126 include the hemispheric bowl 402, the 90° turning lock holder 404, the bottom down holder clamp 406 and a clamp neck 502. The clamp neck 502 joins the shaft (not shown) to the bottom down holder clamp 406. The clamp neck 502 may also act as a stop to prevent the first section from pivoting too far when initially engaging the leadframe or the bonding substrate 108.

Referring now to FIG. 6, therein is shown a front view of the sub-assembly 600 of the tensioner structure 126 of FIG. 1. The tensioner structures 126 include the spring absorber gripper mat 130, the spring absorber 132, the hemispheric bowl 402, the 90° turning lock holder 404, the bottom down holder clamp 406, the clamp neck 502, a shaft 602, a ball bearing 604, a bottom down holder clamp front taper section 606, and a bottom down holder clamp side taper section 608. As mentioned previously, the spring absorber gripper mat 130 holds the spring absorber 132 in place within the one or more heat tunnel top cover apertures 128 formed within the heat tunnel top cover 104, of FIG. 1. The shaft 602 connects the bottom down holder clamp 406 to the hemispheric bowl 402 via the clamp neck 502. As also mentioned previously, the bottom down holder clamp 406, the clamp neck 502, the shaft 602, the hemispheric bowl 402 and the 90° turning lock holder 404 can be formed of one piece construction.

The ball bearing 604 engages the hemispheric bowl 402 when the leadframe or the bonding substrate 108 of FIG. 1 passes underneath the bottom down holder clamp 406. The leadframe or the bonding substrate 108 pushes the bottom down holder clamp 406 upwards, which in turn pushes the hemispheric bowl 402 upwards via the shaft 602. After being displaced upwards a predetermined amount, the hemispheric bowl 402 engages the ball bearing 604. The ball bearing 604 then engages the spring absorber 132, and pushes the spring absorber 132 upwards. The spring absorber 132 being comprised by a resilient member produces a force downwards upon compression. This downward force acts upon the ball bearing 604, which acts as a load transference member for dispensing the downward force upon the hemispheric bowl 402. The hemispheric bowl 402 then dispenses the downward force to the bottom down holder clamp 406 via the shaft 602.

As mentioned above, the bottom down holder clamp 406 is pushed upwards upon engaging the leadframe or the bonding substrate 108. To facilitate engagement of the leadframe or the bonding substrate 108, the bottom down holder clamp 406 includes a bottom down holder clamp front taper section 606 and a bottom down holder clamp side taper section 608. For example and not by way of limitation, the bottom down holder clamp front taper section 606 may be chamfered to about 11° and the bottom down holder clamp side taper section 608 may be chamfered to about 35°. By chamfering the leading edge of the bottom down holder clamp 406, comprised by the bottom down holder clamp front taper section 606 and the bottom down holder clamp side taper section 608, the leading edge of the leadframe or the bonding substrate 108 smoothly slides under the leading edge of the bottom down holder clamp 406, thereby reducing resistance encountered during the drawing process.

Referring now to FIG. 7, therein is shown a top view of the sub-assembly 600 of the tensioner structure 126 of FIG. 1. The tensioner structures 126 includes the spring absorber gripper mat 130, the hemispheric bowl 402, the 90° turning lock holder 404, the bottom down holder clamp 406, and the ball bearing 604. For clarity of illustration, the spring absorber 132 has not been depicted. From this perspective, the spring absorber 132 would be located between the spring absorber gripper mat 130 and the ball bearing 604.

Referring now to FIG. 8, therein is shown a side view of the sub-assembly 600 of the tensioner structures 126, of FIG. 1. The tensioner structures 126 include the spring absorber gripper mat 130, the spring absorber 132, the hemispheric bowl 402, the 90° turning lock holder 404, the bottom down holder clamp 406, the clamp neck 502, the shaft 602, the ball bearing 604, the bottom down holder clamp front taper section 606, the bottom down holder clamp side taper section 608, a bottom down holder clamp bottom polished surface 802, and a bottom down holder clamp rear taper section 804. After passing the leading edge of the bottom down holder clamp 406, comprised by the bottom down holder clamp front taper section 606 and the bottom down holder clamp side taper section 608, the leadframe or the bonding substrate 108 of FIG. 1 then encounters the bottom polished surface 802. The bottom polished surface 802 engages the leadframe or the bonding substrate 108 and clamps it in place, thereby preventing warpage due to, for instance, CTE mismatch.

After passing underneath the bottom polished surface 802, the leadframe or the bonding substrate 108 then passes under the bottom down holder clamp rear taper section 804. The bottom down holder clamp rear taper section 804 is specifically chamfered so as to reduce the stress imparted to the leadframe or bonding substrate 108, as it disengages from the tensioner structures 126. For example and not by way of limitation, the bottom down holder clamp rear taper section 804 may be chamfered to about 35°.

Referring now to FIG. 9, therein is shown a top view of the sub-assembly 600 of the tensioner structures 126 of FIG. 1. The tensioner structures 126 include the spring absorber gripper mat 130, the hemispheric bowl 402, the 90° turning lock holder 404, the bottom down holder clamp 406, and the ball bearing 604. For clarity of illustration, the spring absorber 132 has not been depicted. From this perspective, the spring absorber 132 would be located between the spring absorber gripper mat 130 and the ball bearing 604.

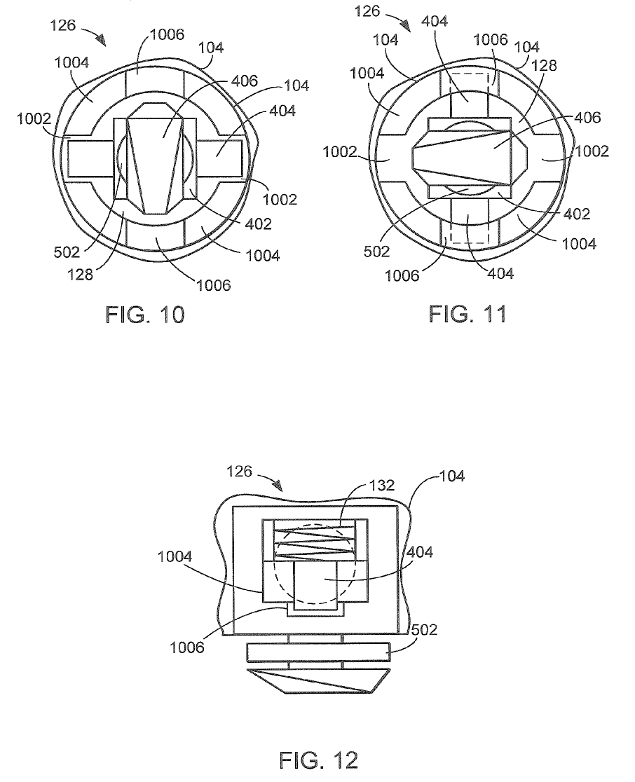

Referring now to FIG. 10, therein is shown a bottom view of the tensioner structure 126 during insertion of the sub-assembly 600 into the tensioner structure 126 in the heat tunnel top cover 104 in accordance with an embodiment of the present invention. A 90° turning lock holder insertion guide 1004 can be machined into the heat tunnel cover 104 or be a separate part inserted into the heat tunnel cover 104. The tensioner structure 126 includes the hemispheric bowl 402, the 90° turning lock holder 404, the bottom down holder clamp 406 and the clamp neck 502. The tensioner structures 126 are inserted into the heat tunnel top cover apertures 128. Each of the heat tunnel top cover apertures 128 includes at least one 90° turning lock holder insertion opening 1002, the 90° turning lock holder insertion guide 1004, and a 90° turning lock holder insertion recess 1006. The 90° turning lock holder insertion opening 1002 is configured to receive the 90° turning lock holder 404.

Referring now to FIG. 11, therein is shown a bottom view of the tensioner structure 126 after locking the sub-assembly 600 into the tensioner structure 126 in the heat tunnel top cover 104 in accordance with an embodiment of the present invention. The tensioner structure 126 includes the hemispheric bowl 402, the 90° turning lock holder 404, the bottom down holder clamp 406 and the clamp neck 502. As mentioned above, the tensioner structures 126 are inserted into the heat tunnel top cover apertures 128 by inserting the 90° turning lock holder 404 into the 90° turning lock holder insertion opening 1002.

After inserting the 90° turning lock holder 404 into the 90° turning lock holder insertion opening 1002, the 90° turning lock holder 404 is rotated 90° along the 90° turning lock holder insertion guide 1004. After rotating 90°, the 90° turning lock holder 404 engages a 90° turning lock holder insertion recess 1006. The downward pressure of the spring absorber 132 (not shown) seats the 90° turning lock holder 404 into the 90° turning lock holder insertion recess 1006. Upon seating, the tensioner structures 126 are locked in place and set to engage the leadframe or the bonding substrate 108, of FIG. 1.

Referring now to FIG. 12, therein is shown a cross-sectional view of the tensioner structures 126 after locking of the sub-assembly 600 into the tensioner structure 126 in the heat tunnel top cover 104 in accordance with an embodiment of the present invention. This view of the tensioner structure 126 depicts how the 90° turning lock holder 404 seats within the 90° turning lock holder insertion recess 1006. The 90° turning lock holder 404 seats into the 90° turning lock holder insertion recess 1006 due to the downward force applied by the spring absorber 132. Upon seating the 90° turning lock holder 404 into the 90° turning lock holder insertion recess 1006, the tensioner structures 126 are locked in place.

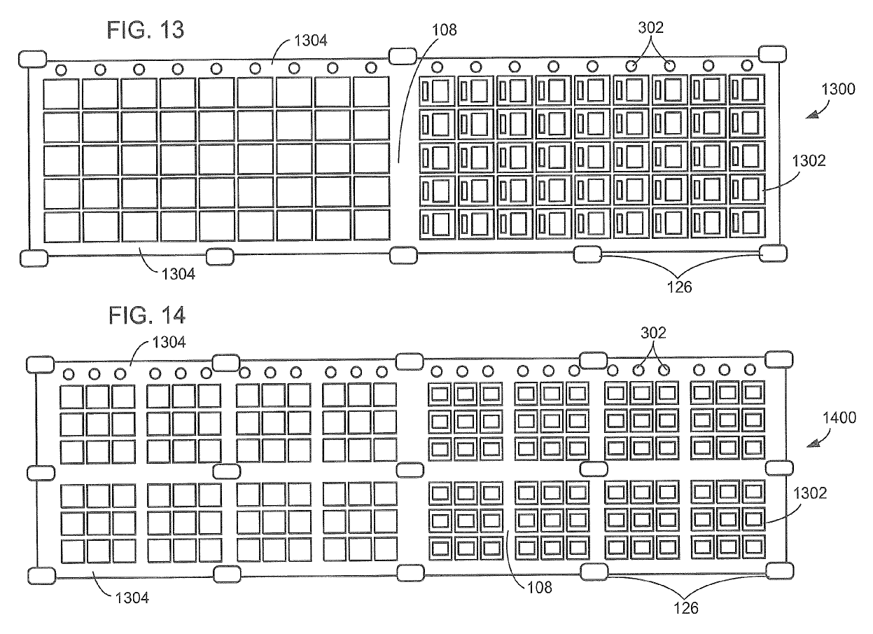

Referring now to FIG. 13, therein is shown a top view of a dual panel bonding substrate 1300 in accordance with an embodiment of the present invention. The dual panel bonding substrate 1300 includes the leadframe or the bonding substrate 108, the tensioner structures 126, the indexing holes 302, and one or more integrated circuit chips 1302. As previously mentioned, the indexing holes 302 engage the indexing pins 110, and walk the leadframe or the bonding substrate 108 through the indexing system. Additionally, as previously mentioned, the tensioner structures 126 engage the leadframe or the bonding substrate 108 and help prevent warpage. The integrated circuit chips 1302 can be comprised by, for example and not by way of limitation, active devices, passive devices, and three dimensional packaging such as package-on-package (“PoP”) and package-in-package (“PiP”).

The tensioner structures 126 can be positioned approximately 50 mm apart between each other on one side of a leadframe or a bonding substrate rail 1304 and approximately 125 mm apart on the other side of the bonding substrate rail 1304. The tensioner structures 126 are placed on opposing sides of the leadframe or the bonding substrate rail 1304 to provide maximum support and thereby provide the greatest protection against warpage. A major application of the present invention can be the die attach process used for assembling Power Quad Flat Non-leaded (PQFN) package with large matrix bonding substrates or leadframes.

Referring now to FIG. 14, therein is shown a top view of a multiple panel bonding substrate 1400 in accordance with an embodiment of the present invention. The multiple panel bonding substrate 1400 includes the leadframe or the bonding substrate 108, the tensioner structures 126, the indexing holes 302, and the integrated circuit chips 1302. As previously mentioned, the indexing holes 302 engage the indexing pins 110 and walk the leadframe or the bonding substrate 108 through the indexing system. Additionally, as previously mentioned, the tensioner structures 126 engage the leadframe or the bonding substrate 108 and help prevent warpage. The integrated circuit chips 1302 can be comprised by, for example and not by way of limitation, active devices, passive devices, and three dimensional packaging such as package-on-package (“PoP”) and package-in-package (“PiP”).

The tensioner structures 126 can be positioned approximately 50 mm apart between each other on one side of the leadframe or the bonding substrate rail 1304 and approximately 50 mm apart on the other side of the leadframe or the bonding substrate rail 1304. Additionally, the leadframe or the bonding substrate rail 1304 can also be placed between smaller panels or integrated circuits to further hold down the leadframe or the bonding substrate 108 by another row of the tensioner structures 126. Approximately 15 units of the tensioner structures 126 are needed per strip and 75 units in total for a whole heat tunnel setup to ensure smooth traveling of the leadframe or the bonding substrate 108 with no warpage. A major application of the present invention can be the die attach process used for assembling Power Single Outline Transistor (PSOT) and Power Single Outline Integrated Chip (PSOIC) package with large matrix bonding substrates or leadframes.

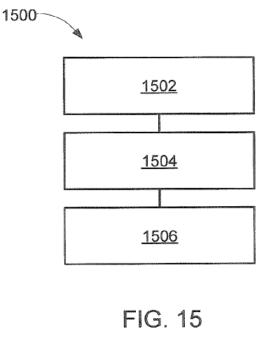

Referring now to FIG. 15, therein is shown a flow chart for a substrate indexing system 1500 in accordance with an embodiment of the present invention. The substrate indexing system 1500 includes aligning a substrate with an indexing system 1502, drawing the substrate along an axis of the indexing system 1504, and engaging the substrate using a self-aligning resilient tensioner with a chamfered edge 1506.

It has been discovered that the present invention thus has numerous advantages. One such advantage is that the present invention prevents leadframe or bonding substrate warpage during indexing. The leadframe or bonding substrate warpage is prevented by using the one or more tensioners. The tensioners provide a load upon the leadframes or bonding substrates that prevents their displacement.

Another advantage of the present invention is the effectiveness of heat transfer from the heater coils in the heat tunnel bed to the leadframe or bonding substrate. Since the leadframe or bonding substrate remains in contact with the heat tunnel bed, the energy/heat transference rate is markedly increased over that of a system wherein the leadframe or bonding substrate does not contact the heat tunnel bed.

Yet still another advantage of the present invention is that the tensioners provide a flat and stable bonding platform for solder dispensing, spanking and mounting. The increased stability in the platform enhances and increases the accuracy of bond placement and bond line thickness.

Yet still another advantage of the present invention is that the tensioners automatically adjust for different leadframe or bonding substrate thicknesses. Since the tensioners are self-aligning there is no machine down time for retooling to accommodate leadframes or bonding substrates of varying thicknesses.

Thus, it has been discovered that the substrate indexing method and apparatus of the present invention furnishes important and heretofore unknown and unavailable solutions, capabilities, and functional advantages for high temperature die mounting. For instance, leadframe or bonding substrate warpage is reduced, heat loss is minimized, bond placement and bond line thickness accuracy is improved, and variable leadframe or bonding substrate thickness is accommodated by an automatically self-adjusting tensioner. The resulting processes and configurations are straightforward, cost-effective, uncomplicated, highly versatile and effective, can be implemented by adapting known technologies, and are thus readily suited for efficient and economical manufacturing.

While the invention has been described in conjunction with a specific best mode, it is to be understood that many alternatives, modifications, and variations will be apparent to those skilled in the art in light of the aforegoing description. Accordingly, it is intended to embrace all such alternatives, modifications, and variations which fall within the scope of the included claims. All matters hithertofore set forth herein or shown in the accompanying drawings are to be interpreted in an illustrative and non-limiting sense.

What is claimed is:

1. A substrate indexing system comprising:
aligning a substrate with an indexing system;
drawing the substrate along an axis of the indexing system; and
engaging the substrate using a self-aligning resilient tensioner with a chamfered edge.

2. The system as claimed in claim 1 further comprising:
configuring the self-aligning resilient tensioner with the chamfered edge to act upon a load transference member.

3. The system as claimed in claim 1 further comprising:
configuring the self-aligning resilient tensioner with the chamfered edge to automatically adjust to varying substrate thicknesses.

4. The system as claimed in claim 1 further comprising:
configuring the self-aligning resilient tensioner with the chamfered edge at parallel peripheral edges of a substrate, between integrated circuits, between panels, or a combination thereof.

5. The system as claimed in claim 1 further comprising:
configuring the self-aligning resilient tensioner with the chamfered edge to possess a tapered leading edge designed to facilitate substrate movement.

6. A substrate indexing system comprising:
indexing a substrate through a heating system including a self-aligned resilient tensioner comprised by a self-aligning resilient member section, a load transferance member section, and a chamfered bottom down holder clamp section;
providing pressure upon a chamfered bottom down holder clamp via a self-aligning resilient member acting upon a load transferance member; and
transmitting the pressure of the chamfered bottom down holder clamp to the substrate by first engaging the substrate via a chamfered surface and indexing the substrate underneath the self-aligned resilient tensioner.

7. The system as claimed in claim 6 further comprising:
configuring the substrate indexing system to minimize heat transfer loss between the heating system and the substrate.

8. The system as claimed in claim 6 further comprising:
configuring the substrate indexing system to provide a substantially flat substrate which improves die attach of integrated circuits.

9. The system as claimed in claim 6 further comprising:
configuring the substrate indexing system to provide a substantially flat substrate which improves bond placement accuracy or bond line thickness.

10. The system as claimed in claim 6 further comprising:
configuring the self-aligned resilient tensioner to continuously hold down the substrate during indexing.

11. A substrate indexing system comprising:
a tensioner, wherein the tensioner includes:
a self-aligning resilient member section,
a load transferance member section, and
a chamfered bottom down holder clamp section.

12. The system as claimed in claim 11 wherein:
the self-aligning resilient member section includes a member capable of generating a load.

13. The system as claimed in claim 11 wherein:
the load transferance member section includes a roundish or oblong member.

14. The system as claimed in claim 111 wherein:
a tapered leading edge of the chamfered bottom down holder clamp is tapered less than a tapered trailing edge.

15. The system as claimed in claim 11 wherein:
the chamfered bottom down holder clamp section includes a leading edge taper of about 11° and a trailing edge taper of about 35°.

16. A substrate indexing system comprising:
a heating system including an indexing arm for moving substrates through the heating system;
a self-aligned resilient tensioner formed within the heating system;
wherein the self-aligned resilient tensioner is comprised by a resilient absorber section containing a resilient member, a load transferance member section, and a chamfered bottom down holder clamp.

17. The system as claimed in claim 16 wherein:
the substrate is a bonding substrate or a leadframe.

18. The system as claimed in claim 16 wherein:
the self-aligned resilient tensioner automatically adjusts to varying substrate thicknesses.

19. The system as claimed in claim 16 wherein:
the self-aligned resilient tensioner configured to prevent warpage of a substrate.

20. The system as claimed in claim 16 wherein:
the self-aligned resilient tensioner is comprised of a tungsten carbide material coated with titanium.
